(19) United States
(12) Patent Application Publication
(10) Pub. No.: US 2009/0319910 A1
(43) Pub. Date: Dec. 24, 2009

(54) AUTOMATIC CONTENT AND AUTHOR EMPHASIS FOR SHARED DATA

(75) Inventors: Daniel Escapa, Redmond, WA (US); David Rasmussen, Redmond, WA (US); Franklin Williams, Seattle, WA (US); Kentaro Urata, Kirkland, WA (US); Donovan Lange, Seattle, WA (US); Olya Veselova, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/143,815

(22) Filed: Jun. 22, 2008

(51) Int. Cl. G06F 17/30; G06F 3/048

(52) U.S. Cl. 715/751; 707/201; 707/E17.009

(57) ABSTRACT

Architecture for emphasizing changes in collaborative or shared documents. A user can now quickly see what content was changed (hence, unread content) since the last time the user viewed the document or page. A tool automatically tracks and annotates the new content and author of the content for collaboration users. The architecture provides author highlighting on a page or document, which is turned on automatically when the user goes to the page or document. Widgets are displayed in association with the unread content that indicate which user authored all or portions of new unread content. Synchronization of the content update document content so that other users can readily see what is new and the author. A master file is created that stores the emphasis information and associated author information. The file can be stored at any location that is accessibly by the collaborative clients.

### BACKGROUND

Collaboration software is a tool that allows multiple users to access the same information for the purpose of serving a common goal. Companies employ collaboration to improve communications between project teams, for example. Currently, when users collaborate using collaboration applications, there is a problem of knowing which user entered specific content of the document, when that content was entered, and which content the user has not viewed. For example, when a user opens a document the user is presented with a page that contains no indicators as to which user wrote what parts of the document and which users were involved.

For example, where a first user is working with other users on a team and requests that the other team users review some plans available in a shared notebook (e.g., a note pad for jotting down notes), there is no indication other than manual annotations as to which user may have entered content. When accessing the notebook not only do the other users not know if content is new, but when accessing a page with new changes it is difficult if not impossible to see what content was changed. Moreover, when there are many authors on the page it is difficult to see which user entered or edited the content.

The lack of mechanisms to determine new content and the content author(s) are counter to a sense of collaboration in shared notebooks. In one particular network-based application, wikis are collaborative websites where users can contribute information and knowledge on a wide variety of topics. Knowing what content has changed in a shared notebook as well as wikis is tantamount to a better collaborative experience.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture enhances how people can collaborate in a shared note-taking application (notebook). A user can now quickly see what content was changed since the last time the user viewed a document or page. In an alternative configuration, a user can see what content the user has not yet read. This is accomplished while the user client is offline, and without the use of a server. The architecture tracks online/offline state of a client based on timestamps and synchronization techniques.

The architecture is a tool that automatically tracks and annotates the new content and author of the content for collaboration users. Moreover, the tool improves the realtime communication experience to view what users have/have not been writing. Users no longer need to manual interact to see what content is new.

The architecture provides author highlighting on a page or document, which is turned on automatically when the user goes to the page or document. Moreover, user widgets are displayed indicating which user wrote all or portions of new unread content.

In operation, when a user opens (or views) a page or document in a shared notebook, the changes made by other users are automatically highlighted since the last visit the user made to the page or document. The highlighting on the page or document is different for each author and the highlighting is next to each type of content the user authored.

To the accomplishment of the foregoing and related ends, certain illustrative aspects are described herein in connection with the following description and the annexed drawings. These aspects are indicative of the various ways in which the principles disclosed herein can be practiced, all aspects and equivalents of which are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented data emphasis system.

FIG. 2 illustrates a more detailed data emphasis client.

FIG. 3 illustrates a system that employs automatic content emphasis and author identification in a web-based collaboration environment.

FIG. 4 illustrates a screenshot of an exemplary client UI for automatic content emphasis and author identification in a notebook collaboration environment.

FIG. 5 illustrates a UI part that presents unread content indications by the notebook title in the UI of FIG. 4.

FIG. 6 illustrates a UI part that presents unread content indications by the notebook title in the UI of FIG. 4.

FIG. 7 illustrates a screenshot of a view of the exemplary client UI of FIG. 4 that shows author widgets for identification in a notebook collaboration environment.

FIG. 8 illustrates a method of turning on/off author highlighting.

FIG. 9 illustrates a method of emphasizing shared data.

FIG. 10 illustrates a block diagram of a computing system operable to execute content and author emphasis in accordance with the disclosed architecture.

FIG. 11 illustrates a schematic block diagram of an exemplary computing environment that facilitates author and content emphasis.

### DETAILED DESCRIPTION

The disclosed architecture provides indicators to program viewers as to new content in a collaborative page or document and the author of the new content. This is performed and displayed automatically to the user when the user accesses the shared document. In one specific implementation, the architecture automatically highlights the content changes made by other users in a virtual notebook of multiple documents or pages. When a user visits a shared notebook page the changes are automatically emphasized for that specific viewer. In other words, the same page viewed by another user will be presented differently insofar as the highlighted (or emphasized) content and author identifiers. Thus, users can quickly perceive what content has changed and by which author. The architecture finds particular applicability to wikis, collaborative environments, and ad hoc networks where users share and view common documents.

Note that as used herein, the term “highlight” or variations thereof is intended to mean that emphasis is added or applied to the data. The emphasis can be in the form of transparent coloration imposed over the unread text or data, changes in font, bolding of the data, italicizing, etc., or any emphasis that denotes the data or text with distinctiveness.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives falling within the spirit and scope of the claimed subject matter.

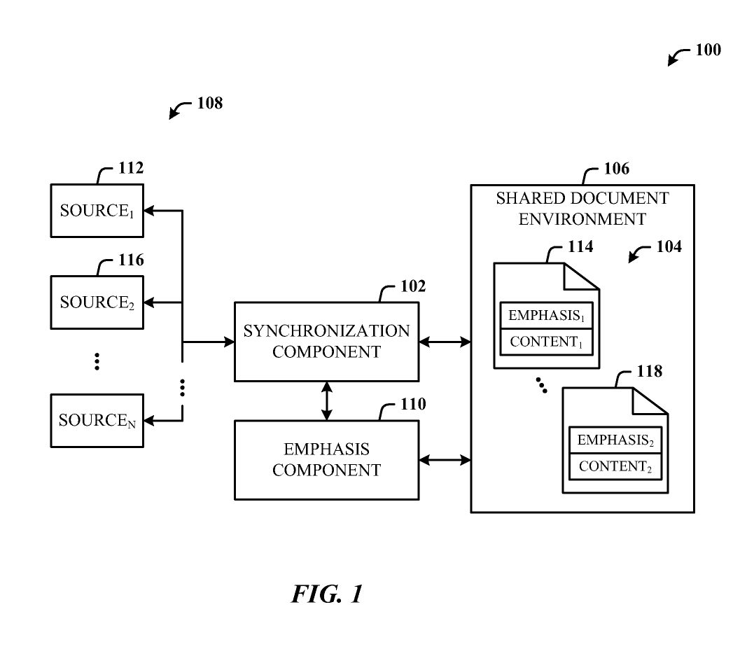

FIG. 1 illustrates a computer-implemented data emphasis system 100. The system 100 includes a synchronization component 102 for synchronizing changes to content (CONTENT) of one or more shared documents 104 of a shared document environment 106, the changes received from one or more sources 108. The system 100 also includes an emphasis component 110 for automatically applying visual emphasis (EMPHASIS) to the changed content that is also unread content. The synchronization component 102, emphasis component 110, and other functionality described herein, provide this capability in an offline state and without a server (as well as in an online state). The visual emphasis is distinctive on a per-source basis. In other words, each of the sources 108 will be assigned a distinctive visual emphasis, such as a highlighting color (e.g., yellow, blue, red, etc.), such that when a user views a page or a document, the unread content will be distinguishable and attributable to a particular source (or user). It is to be appreciated that the emphasis is not limited to highlighting, but can include any type of visually distinguishing characteristics; alternatively, underlining, bolding, different font, italics, etc., or a combination of the above, such as yellow highlighting of italicized text.

For example, a first source 112 (e.g., an author or user) can be assigned (or mapped) to a first emphasis (denoted EMPHASIS₁) for first content (denoted CONTENT₁) in a first page or document 114 that the first source 112 entered into (or changed, edited, etc.) the first page or document 114. Similarly, a second source 116 (e.g., an author, system) can be assigned (or mapped) to a second emphasis (denoted EMPHASIS₂) for second content (denoted CONTENT₂) in a second page or document 118 that the second source 116 entered, changed, edited, etc., in the second page or document 118. It is also to be understood that multiple sources 108 can make correspondingly multiple changes to content on the same page or document, for example the first document 114. Each separate piece of content will then be emphasized differently to readily differentiate the unread content as being from different sources.

The visual emphasis applied by the emphasis component 110 can also be employed to annotate the unread content with a source identifier (e.g., author name, author name initials, alias, thumbnail photo, icon, audio snippet, etc.). In one example, the source is an author and the source identifier can be initials of the author name. Additionally, the author identifier (e.g., initials) can be as a widget proximate the changed and now unread content provided by the author.

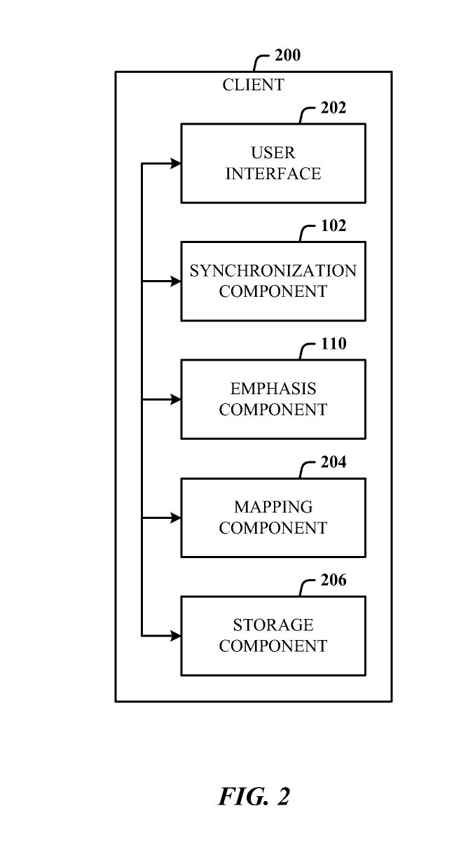

FIG. 2 illustrates a more detailed data emphasis client 200. The synchronization component 102 and the emphasis component 110 are embodied as part of a client 202 that interacts with the shared document environment 106. The synchronization component 102 synchronizes changes to content of one or more shared documents. The emphasis component 110 automatically applies visual emphasis (e.g., highlighting) to the changed content that is also unread content.

The client 200 includes a user interface (UI) 202 for presenting the one or more shared documents for user interaction, the unread content with the distinctive visual emphasis, and source identifier for each piece of the unread content. The client 200 can also include a mapping component 204 for mapping a source to a color (e.g., highlight colors to authors). The mapping can accomplished using a hash of the user (author) name, and then mapping the hash to a color, for example, or other type of emphasis. Thus, a user will have the same color on different computing systems when accessing the same documents. The mapping component 204 can also map emphasis types (e.g., highlight, font, style, etc.) to the authors. For example, a first author can be mapped to a yellow highlight, whereas a second author can be mapped to a green highlight, and a third author can be mapped to boldface text.

These mappings can be stored in a storage component 206. Storing the hashed colors facilitates the benefit of allowing users to modify the colors for particular purposes (e.g., supervisor's color is red, rather than the default hash).

Alternatively, hashed colors can be re-hashed at runtime on each application instance. In this case, since the colors are hashed deterministically, the colors are not stored. This also can include the embodiment of hashing on each client machine.

The storage component 206 can be a file, rather than a folder. The file is accessible by all sources in order to obtain not only mapping information but other management or configuration information as well. The storage component 206 can be utilized to store configuration (management) information associated at least with the unread content, read content, mapping information, source identity, and source color. In this particular illustration, the storage component 206 is on the client 200. However, the storage component 206 that includes the management information can be stored at any accessible location, thereby maintaining the mapping across all of the sources.

In other words, the client 200 includes a data emphasis system that comprises the synchronization component 102 for synchronizing changes to content of one or more shared documents, the changes generating new content received from one or more users, the emphasis component 110 for automatically applying visual emphasis to the changed content that is unread, the visual emphasis distinctive on a per-user basis, and the user interface 202 for presenting the one or more shared documents, the unread content with the distinctive visual emphasis, and author identifier for each piece of the unread content.

The user interface 202 generates and presents a floating legend of author colors mapped to author identification. The legend automatically presents the author information for unread content on a document. The emphasis component 110 automatically manages visual emphasis based on navigation away from a page and user interaction with a page. The storage component 206 that is accessible by client that accesses the one or more shared documents. The storage component can be or include a master file that stores mappings of authors and corresponding emphasis information for application to the unread content by the emphasis component 110.

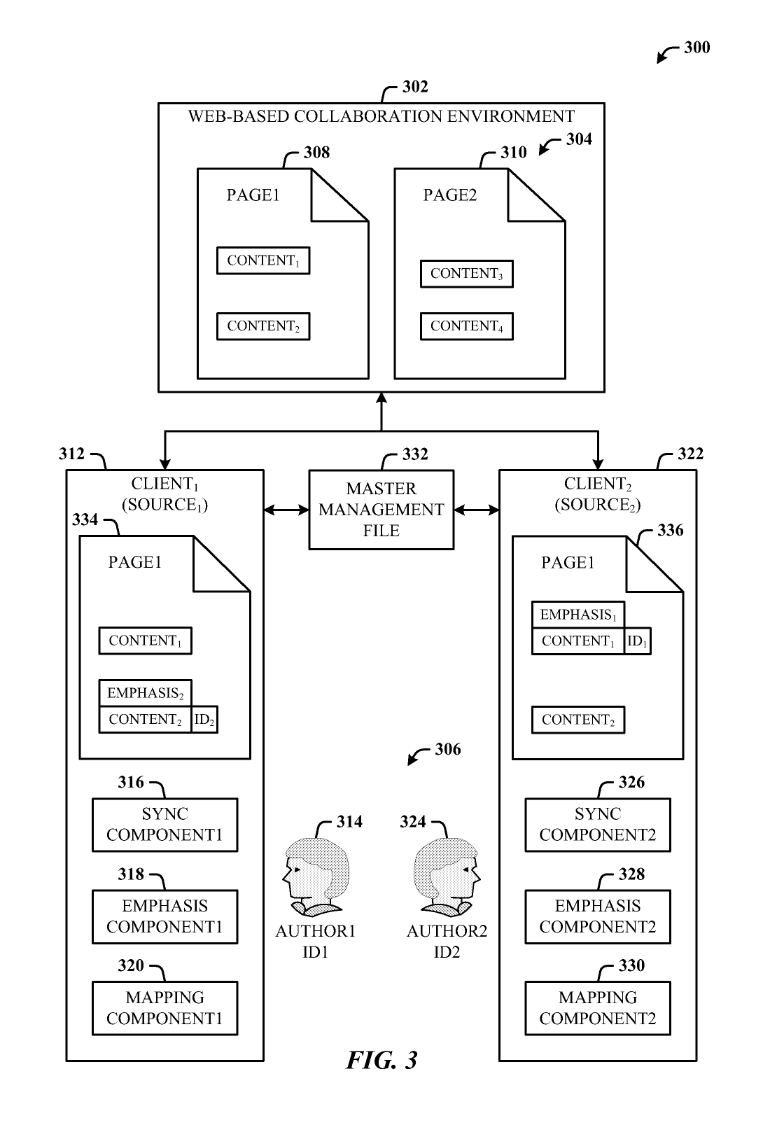

FIG. 3 illustrates a system 300 that employs automatic content emphasis and author identification in a web-based collaboration environment 302. The environment 302 includes one or more pages 304 which multiple users 306 can access for viewing and/or editing. In one example, the environment 302 can be a wiki which users 306 can access and enter/edit information on pages 304 that present information on many different topics. However, it is to be appreciated that a wiki is just one example. This applies to any case of a shared notebook and/or shared location. Here, the environment 302 hosts two pages on which the users 306 can collaborate: a first page 308 and a second page 310. The first page 308 includes two pieces of content: a first content (CONTENT1) and a second content (CONTENT2). The second page 310 includes two pieces of content: a third content (CONTENT3) and a fourth content (CONTENT4).

A first client 312 provides the interface to a first author 314 (AUTHOR1) for accessing the environment 302 and the environment pages 304. The first client 312 includes a first sync component 316, a first emphasis component 318 and a first mapping component 320, as well as an interface component (not shown), the functionality and operation of which are described herein.

Similarly, a second client 322 provides the interface to a second author 324 (AUTHOR2) for accessing the environment 302 and the environment pages 304. The second client 322 includes a second sync component 326, a second emphasis component 328 and a second mapping component 330, as well as an interface component (not shown), the functionality and operation of which are described herein.

The client synchronization component and the emphasis component operate in cooperation with the collaboration website to process changes to the shared content (e.g., web page content), wherever the content is stored, synchronizes the changes to the one or more sources (clients 312 and 322). The changes are visually and distinctively emphasized on each of the one or more sources (clients 312 and 322) according to the source that makes the change.

As stored in the environment 302, the content of the pages 304 is not annotated (with author ID) or emphasized in any way. In other words, a user system not using the disclosed architecture will not obtain the benefits of seeing author IDs and content emphasis that mark unread content.

In this particular example, assume that the first author 314 and second author 324 are accessing the same first page 308 of the environment 302, and that the first author edited (or is editing) the first content CONTENT1, and the second author 324 is entering (or editing) the second content CONTENT2. As is described hereinbelow, there can be several actions that will trigger content as being emphasized as unread, such as making a single edit, for example.

As processed and presented on the first client 312, the first author 314 will see a first client page 334 (of the first page 308) showing the first content CONTENT1 on which the first author 314 is working, and the second content CONTENT2 with emphasis EMPHASIS2 and a second author identifier ID2 clearly indicating visually to the first author 314 that the second content CONTENT2 is unread and that it was (or is being) edited by the second author 324.

As processed and presented on the second client 322, the second author 324 will see a second client page 336 (of the first page 308) showing the second content CONTENT2 on which the second author 324 is working, and the first content CONTENT1 with emphasis EMPHASIS1 and a first author identifier ID1 clearly indicating visually to the second author 324 that the first content CONTENT1 is unread and that it was (or is being) edited by the first author 314.

A master management file 332 (e.g., a storage component) can be accessed by both the clients (312 and 322) to obtain the mapping information stored therein. Thus, emphasis colors for highlighting for a given author can be obtained and applied by the respective clients (213 and 322). Similarly, the mapping of the author ID to the color (or other emphasis information) can be obtained to further present the author ID as part of a widget next to the highlighted content that was changed by the author and which is now unread. The master file 332 ensures that no two emphasis information are the same, but are distinctive and carried across the many pages 304. This applies to the author information and IDs as well.

The master management file 332 as shown is not stored in any particular location; however, the file 332 can be stored at any location accessible to the clients (312 and 322), such as the first client 312, the second client 322, a server that hosts the environment 302, or a different location.

Note that the master management file 332 (or another file) can be utilized to store a history of changes by author, date, color, the change itself, timestamp, etc., thereby providing a searchable dataset that a user can search for further information. For example, a user can then search for the color yellow on all pages (e.g., pages 1 and 2). Further, the search can be over a given time period, for example, or by author, and so on. It is to be appreciated that the information stored in the master file 332 is not limited by amount or purpose.

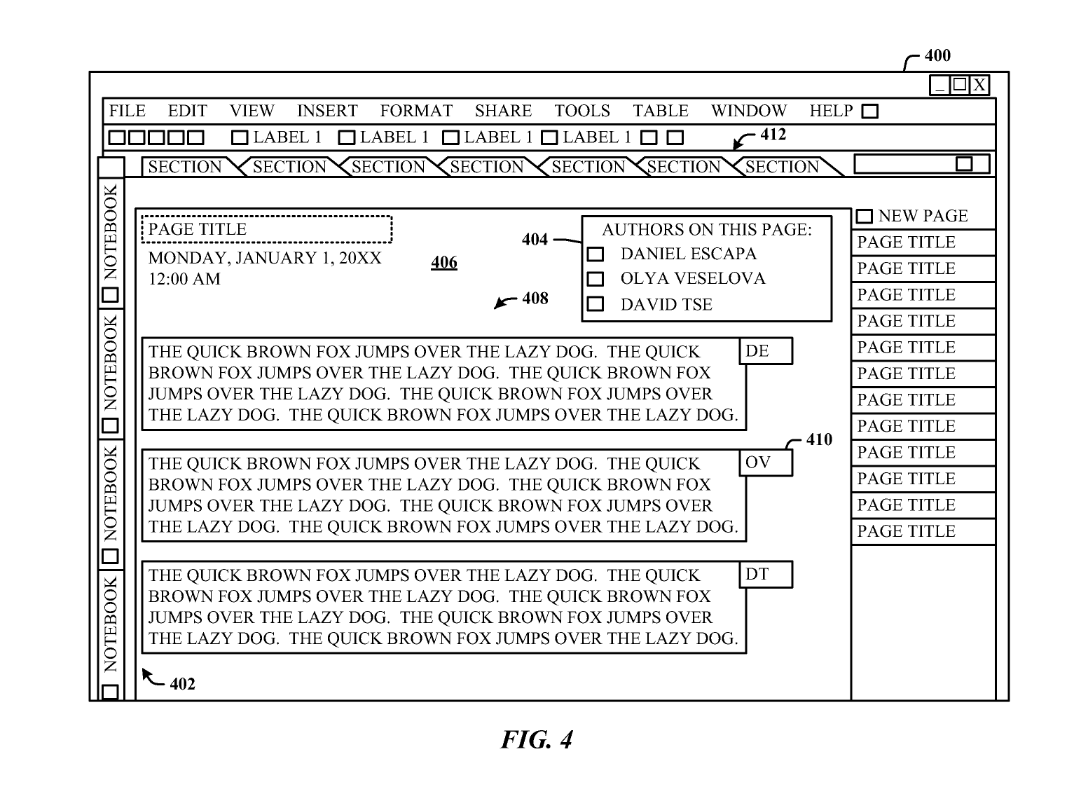

FIG. 4 illustrates a screenshot of an exemplary client UI 400 for automatic content emphasis and author identification in a notebook collaboration environment. The UI 400 shows a listing 402 of four notebooks (denoted NOTEBOOK) that are accessible along the left side. A legend 404 in the top of the UI 400 slows the most common authors on the page. The legend 404 can float along the page 406 as the user scrolls up/down. The legend 404 can contain the most recent authors; however, if there are many authors on the page 406 the legend 404 can launch into a task pane or extended view to present more information.

The content 408 edited by the author is highlighted by the same color assigned to that author that appears in the legend 404. Each piece of content 408 is highlighted, and in one implementation there is an annotation 410 positioned on the top right of each content object showing the initials of the author that edited the content. If the viewing user hovers a pointing device over the annotation 410, a tooltip can be configured to appear that indicates the time and the full name of the author of the content on the page 406.

In one implementation, items that are changed in that editing session can be emphasized by a glow effect. Edits by author can be grouped per time periods buckets such as “Today”, “Yesterday”, “This week”, “Older”. The legend 404 can also include a link into a search or a more detailed view. Keyboard shortcuts can be employed as well.

With respect to highlighting as a form of visual emphasis, there can be a mode where when the user accesses a page with unread content (unread content being content not written or edited by the viewer) that is highlighted. Additionally, information can be presented indicating when the editing occurred and by which user (author). In another mode, highlighting can be turned on for the whole page by a menu selection.

The UI 400 also includes a Section area 412 section tabs that show the sections of the selected notebook from the listing 402. Thus, the user can quickly enter the desired section of the notebook from the listing 402. The sections can be chapters, for example, or the individual pages.

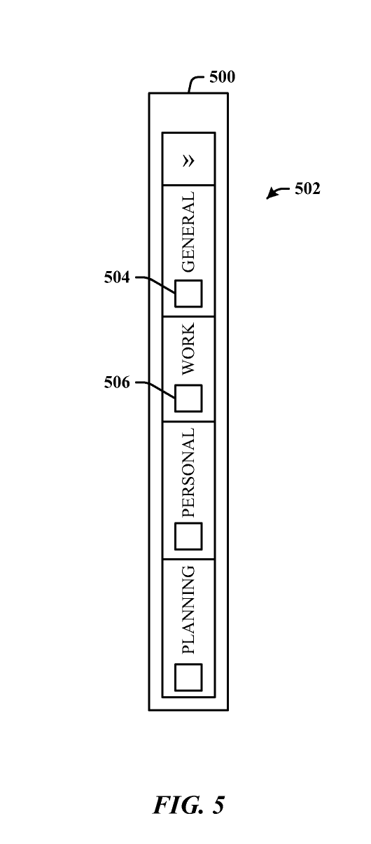

FIG. 5 illustrates a UI part 500 that presents unread content indications by the notebook title in the UI 400 of FIG. 4. Here, the four notebooks 402 of FIG. 4 are customized to General, Work, Personal, and Planning notebooks 502. The UI part 500 not only shows that all of the notebooks 502 are stored on a server (by the icon 504), but also shows that the notebooks are in sync (by the icon symbol 506). Additionally, notebooks General and Personal are emphasized with boldface type to indicate that this is unread content in those notebooks. This will allow users to quickly see when new content is in a notebook. The bolding can be maintained as long as the notebook contains unread content.

When the notebook icons are collapsed, indicators can still be presented that show the user that there are unread items in that notebook. In one example, if the notebook name's text does not appear, this can be an indication that there is not unread content for that notebook for the user to view.

This bolding can also be applied to the headings of the section tabs of the Section area 412 of FIG. 4 to indicate that when unread content can be viewed in the tabbed section.

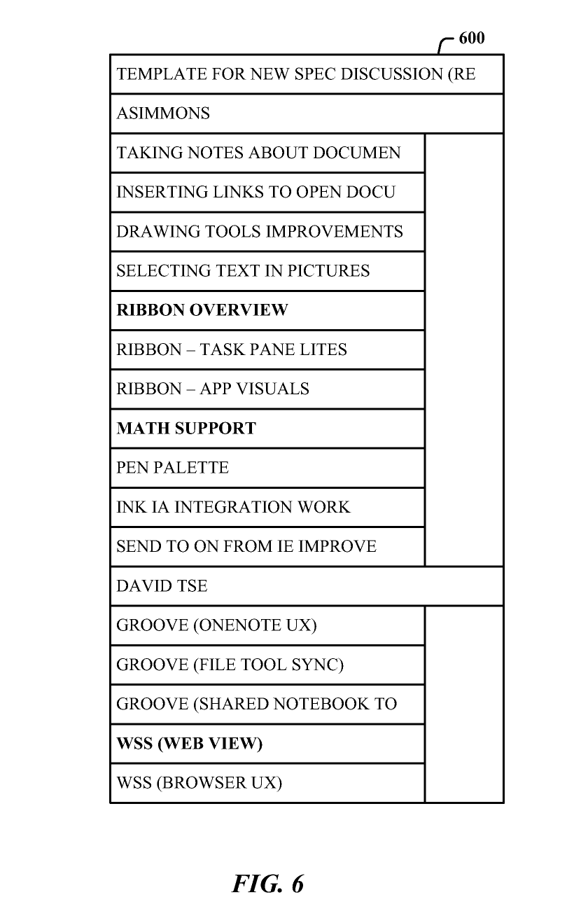

FIG. 6 illustrates a UI part 600 that presents unread content indications by the notebook title in the UI 400 of FIG. 4. The page is the lowest level of what is considered unread, and the user sees this with small updates to the page section tabs. When the user selects a tab, the UI part 600 is presented. Here, there are three pages with unread content as indicated in boldface text: Ribbon Overview, Math support and WSS (Web View).

The following actions trigger the presence of new content in a section of a page or document, and then automatically enable the unread highlighting features: new page, a page with new content, and pages with changed content. Changes that can be ignored for the unread highlighting feature include deleted pages, deleted sections, page reordering, and moving a page into a topic. Random touches on the file which causes a save will not trigger unread highlighting.

For each notebook, there is an option to turn on/off the unread highlighting feature. The notebooks that turn this option on by default include a notebook that is not in the user's documents folder, and a notebook stored on a remote server (on a remote storage system), for example.

Generally, whenever a sub-item has changed then the parent is updated. When a page contains unread content, the page, section, section group and notebook will all be bold in the UI to show off the unread status. If a parent container no longer contains pages of unread content then the container will no longer be unread as well. If there is only one page with edits, once the user is on that page the entire notebook is marked as read as well.

With respect to storage (the master management file), there are two parts. When a user reads/visits a page a last viewed timestamp (LVT) is set on a page. When navigating to a page with new content, all content with a last modified time (LMT) (the time the page was last changed by a user) more recent than the LVT is to be highlighted. Once the user has visited a page based on some configurable time limit (e.g., three seconds) or based on detection of some configurable event the LVT can be updated with the current time. Additionally, the LVT can be updated as the user navigates to different pages. A property can be stored on a section and a notebook indicating that there are unread items within the section and notebook. As synchronization and reading of the pages occurs this property is updated.

In one implementation, the user can mark a page as being unread, in which case the LVT is rolled back to either the previous LVT. In another implementation, the LVT can be cleared entirely to mark the whole page as unread.

The client becomes aware of new content based on storage code. When synchronization occurs and new content is inbound, the new content is marked as unread. Thereafter, emphasis and author IDs are applied for presentation.

Following is a life cycle description of read and unread. When a notebook is opened for the first time all items in a notebook are marked as read. As the client syncs and gets new content, the client UI will be bolded throughout. New content occurs when: new content is synced from the master copy of the file, a merge occurs on an existing section since the section contains new content from the master, or when a new section is created (either because of merge or brand new content from the master copy). It is to be appreciated that other effects can be employed to indicate that pages have been edited. For example, gestures such as italics, icons, and glowing the page tab are techniques that can be employed.

When the user navigates to the page with unread changes the client automatically highlights the new content. New content is highlighted (e.g., in yellow). When the user has viewed the page for more than three seconds the page will become ‘read’ and the client updates the UI once the user has navigated away from the page. If the user was on the page for less than three seconds the unread bold will not go away (unless the user does so with a command). If this page was the only unread page in that section then the section tab will no longer be bolded (and upwards through the hierarchy). On the next sync new items show indicators when there was new content added. It is to be understood that the use of a time-based metric is just one way of determining if a page has been read. For example, other techniques can employ typing or scrolling down to indicate if the page has been read.

Update can occur on page the user is viewing. If the user is viewing a page with the new content syncing in, the following can occur. The user is viewing or editing the page, the sync occurs and new content comes in, a page tab becomes bolded, and the new page content will turn yellow. If the user stays on the page for more than three seconds and then navigates away, the unread indicator will turn off. If the user is editing content, the highlighting will stay as long as the user is on the page. A command can also be provided which enables a user to manually turn highlighting off. Alternatively, for example, animation or fade-in transitions may be used to draw attention to the new change, or make the change less visually disruptive.

The read/unread state can be output via an API for other purposes, such as logging. Moreover, a user can mark as page as unread/read via the API.

The UI also allows a user to navigate through an entire notebook (or all of the notebooks) and view all content that is new (unread). Thus, the user is not constrained to viewing all the content. A button can be provided that skips over the read content to the next unread piece of content. When the user clicks this button, this starts in the current section looking for the next unread page in that section, and then moved to the next section to the right and so on. This can continue by going into section groups and continuing on the top-down, left-right motion through all of the unread changes in a notebook. With just one click the user can go through all unread changes.

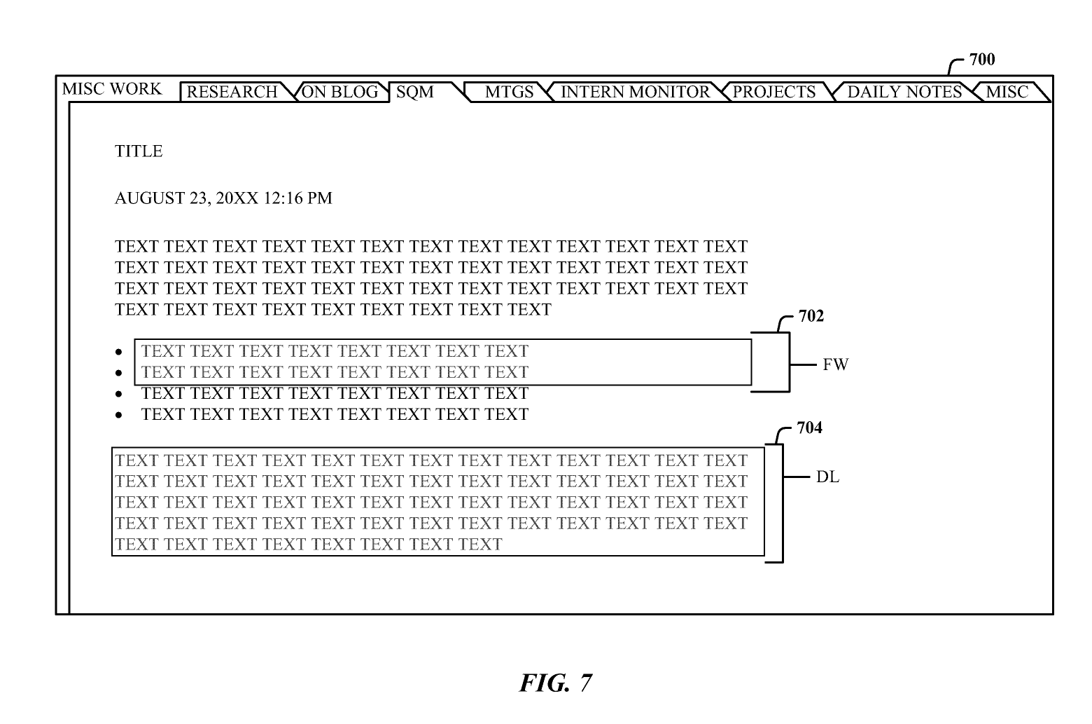

FIG. 7 illustrates a screenshot 700 of a view of the exemplary client UI 400 of FIG. 4 that shows author widgets for identification in a notebook collaboration environment. Here, author initials FW are tagged to a first widget 702 for unread content, and author initials DL tagged to a second widget 704 for unread content of a content object. The widgets are automatically sized for the particular piece of unread content, and then the author initials attached. The author widget can be made interactive such as when hovering the mouse pointer near or over the widget, or via mouse clicks, for example.

With respect to author highlighting, in an alternative implementation, each individual author unread content is not a different color. Instead, new unread content is automatically highlighted in the same color (e.g., green) and the author information is presented via the author widget. When the user wants to see all of the authors on a page, all of the author widgets are displayed for all of the content on the page.

Following is a series of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

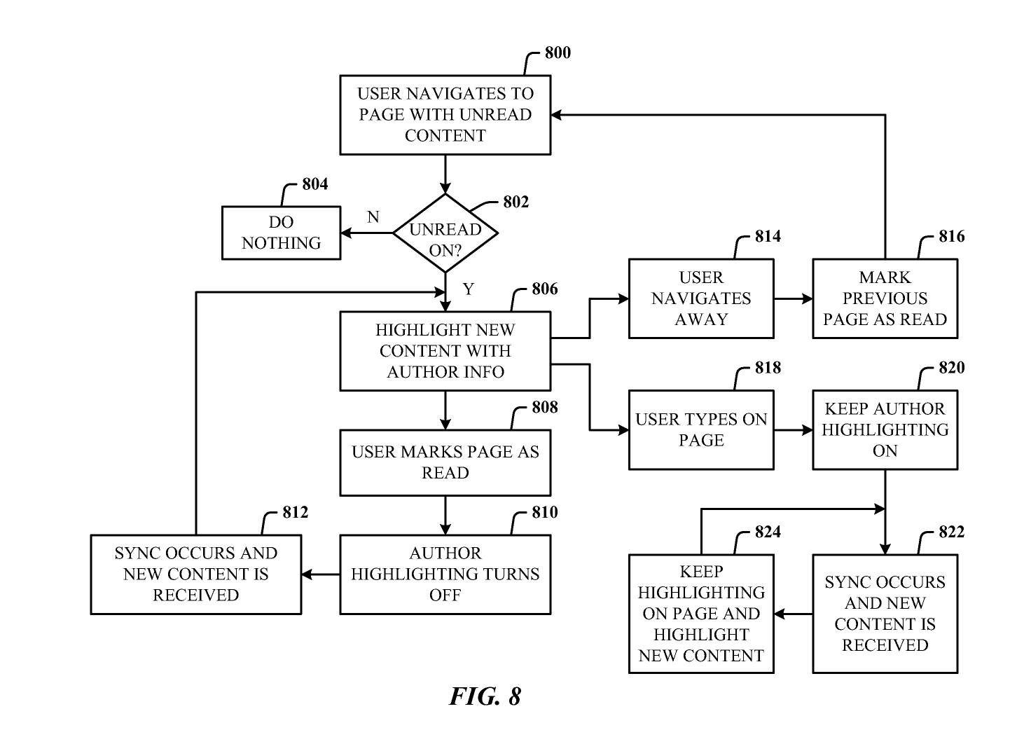

FIG. 8 illustrates a method of turning on/off author highlighting (or emphasis). Author highlighting (e.g., color and author widget) can be turned on when the user visits a page which has unread content in a notebook the unread highlighting feature is enabled. At 800, when the user navigates to a page the new (unread) content. At 802, a check is made to determine if the unread function is on. If not, flow is to 804, to do nothing. If the unread is on, flow is from 802 to 806 where the new content is highlighted and the user can see the author information by default. The highlighting can remain on unless the user marks the page as read. At 808, the user marks the page as read. At 810, the user (author) turns the highlighting off. At 812, a synchronization (sync) process occurs and new content is received. Flow is then back to 806 to then highlight the new content received with author information.

At 806, after the new content is highlighted, the user can navigate away from the page, as indicated at 814. At 816, based on this navigation, the page is automatically marked as read. Flow is then back to 800. Alternatively at 806, the user can type on the page, as indicated at 818. In response, the client keeps the author highlighting on, as indicated at 820. At 822, a sync process occurs and new content is received. At 824, highlighting is kept on the page and the new content is also highlighted. Flow is then back to 822 to continue the highlighting based on the new unread content.

The author widget can be turned on when a user is viewing a page and the user clicks a “show author button” on a menu. This shows the author information for all content on the page. The author feature is on for a particular notebook (or document set) until the user turns the feature off again by clicking the “show author button” (this persists between sessions). This feature does not affect the author highlighting feature. If the user has turned on the “show authors” feature then all of the author widgets can be displayed and the new content will continue to be highlighted in (e.g., in a color green). Alternatively, the widget functionality can be turned on all the time or by default, each of which can be configurable settings.

With respect to the author widget, the widget is presented in proximity to the content of the associated author. In one example, the widget appears to the right of the unread (or new) content for which the author information is being displayed. If the same user has authored a group of content in a single session then the author widget extends to include all of that author's edits. The widget appears to the right of the right edge of any outline or page level object. This means the widget appears along the right side of an outline's box so when present the widget will not get in the user's way. The widget can overlap on top of other content on the page.

In one implementation, the author information of the new content can also display presence information as to whether the author is online, offline, etc. If the user presence information is not available, and the user's initials can be displayed.

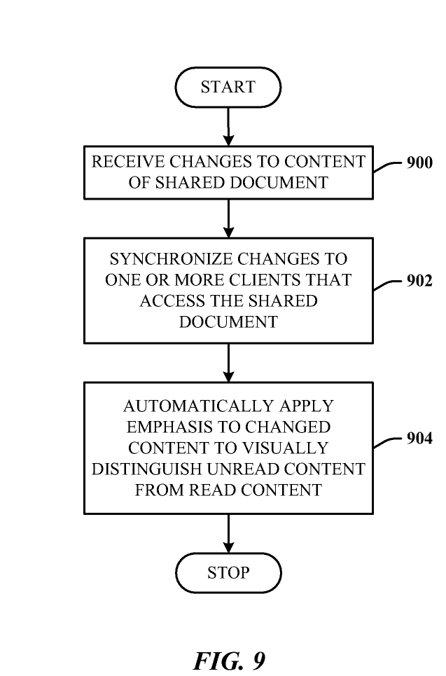

FIG. 9 illustrates a method of emphasizing shared data. At 900, changes to content of a shared document are received. At 902, the changes are synchronized to one or more clients that access the shared document. At 904, emphasis is automatically applied to the changed content to visually distinguish unread content from read content.

The method can further comprise automatically marking the unread content with author information which indicates an author of the changed content. The synchronization process automatically marks the changes as new content when receiving the changes.

The method can also include storing a mapping of emphasis information and author information in an accessible file for processing by the one or more clients that access the shared document.

The method can include generating and presenting a resizable widget in association with the changed content, where the widget defines the changed content and presents author information for an author of the changed content.

For more visual enhancement, the method can further comprise automatically applying emphasis to a notebook graphic of a notebook that includes the document and a section of the notebook in which the document is stored. This can occur during an offline state and without the utilization of a server.

The method can further comprise defining a relationship of different emphasis for correspondingly different authors of unread content to visually distinguish the unread content and authors in the shared document, and maintaining the relationship across different clients and machines.

While certain ways of displaying information to users are shown and described with respect to certain figures as screenshots, those skilled in the relevant art will recognize that various other alternatives can be employed. The terms “screen,” “screenshot”, “webpage,” “document”, and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

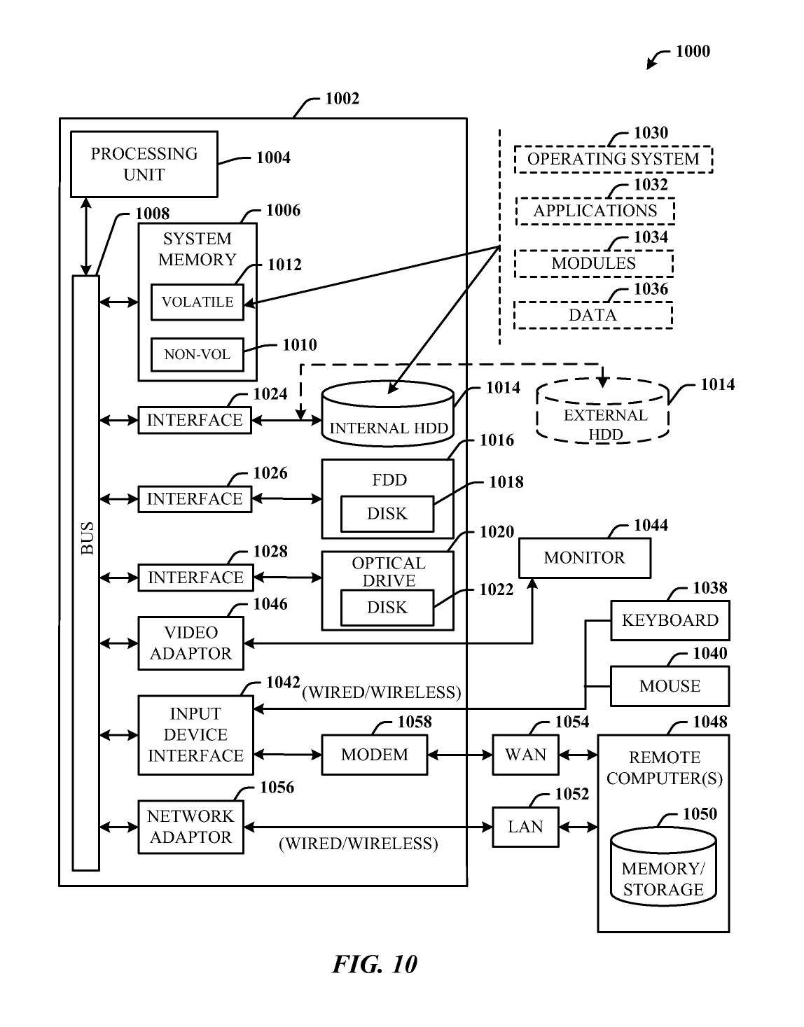

Referring now to FIG. 10, there is illustrated a block diagram of a computing system 1000 operable to execute content and author emphasis in accordance with the disclosed architecture. In order to provide additional context for various aspects thereof, FIG. 10 and the following discussion are intended to provide a brief, general description of a suitable computing system 1000 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 10, the exemplary computing system 1000 for implementing various aspects includes a computer 1002 having a processing unit 1004, a system memory 1006 and a system bus 1008. The system bus 1008 provides an interface for system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 can include non-volatile memory (NON-VOL) 1010 and/or volatile memory 1012 (e.g., random access memory (RAM)). A basic input/output system (BIOS) can be stored in the non-volatile memory 1010 (e.g., ROM, EPROM, EEPROM, etc.), which BIOS are the basic routines that help to transfer information between elements within the computer 1002, such as during start-up. The volatile memory 1012 can also include a high-speed RAM such as static RAM for caching data.

The computer 1002 further includes an internal hard disk drive (HDD) 1014 (e.g., EIDE, SATA), which internal HDD 1014 may also be configured for external use in a suitable chassis, a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as a DVD). The HDD 1014, FDD 1016 and optical disk drive 1020 can be connected to the system bus 1008 by a HDD interface 1024, an FDD interface 1026 and an optical drive interface 1028, respectively. The HDD interface 1024 for external drive implementations can include at least one or both of Universal Serial Bus (USB) and IEEE 1394 interface technologies.

The drives and associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette (e.g., FDD), and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and volatile memory 1012, including an operating system 1030, one or more application programs 1032, other program modules 1034, and program data 1036. The one or more application programs 1032, other program modules 1034, and program data 1036 can include the synchronization component 102, emphasis component 110, client 200, user interface 202, mapping component 204, storage component 206, clients (312 and 322), respective client components (316, 318, and 320 or 326, 328 and 330), page 334 or 336, UI 400 (and entities described in association therewith), the UI parts (500, 600 and 700), and the methods of FIG. 8 and 9, for example.

All or portions of the operating system, applications, modules, and/or data can also be cached in the volatile memory 1012. It is to be appreciated that the disclosed architecture can be implemented with various commercially available operating systems or combinations of operating systems.

A user can enter commands and information into the computer 1002 through one or more wire/wireless input devices, for example, a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces such as a parallel port, IEEE 1394 serial port, a game port, a USB port, an IR interface, etc.

A monitor 1044 or other type of display device is also connected to the system bus 1008 via an interface, such as a video adaptor 1046. In addition to the monitor 1044, a computer typically includes other peripheral output devices (not shown), such as speakers, printers, etc.

The computer 1002 may operate in a networked environment using logical connections via wire and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wire/wireless connectivity to a local area network (LAN) 1052 and/or larger networks, for example, a wide area network (WAN) 1054. Such LAN and WAN networking environments are commonplace in offices and companies, and facilitate enterprise-wide computer networks, such as intranets, all of which may connect to a global communications network, for example, the Internet.

When used in a LAN networking environment, the computer 1002 is connected to the LAN 1052 through a wire and/or wireless communication network interface or adaptor 1056. The adaptor 1056 can facilitate wire and/or wireless communications to the LAN 1052, which may also include a wireless access point disposed thereon for communicating with the wireless functionality of the adaptor 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wire and/or wireless device, is connected to the system bus 1008 via the input device interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with wire and wireless devices or entities using the IEEE 802 family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

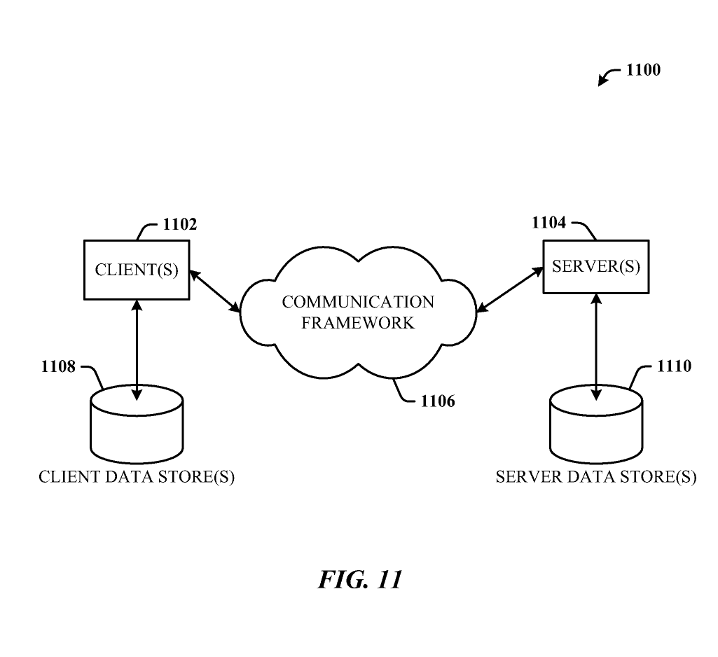

Referring now to FIG. 11, there is illustrated a schematic block diagram of an exemplary computing environment 1100 that facilitates author and content emphasis. The environment 1100 includes one or more client(s) 1102. The client(s) 1102 can be hardware and/or software (e.g., threads, processes, computing devices). The client(s) 1102 can house cookie(s) and/or associated contextual information, for example.

The environment 1100 also includes one or more server(s) 1104. The server(s) 1104 can also be hardware and/or software (e.g., threads, processes, computing devices). The servers 1104 can house threads to perform transformations by employing the architecture, for example. One possible communication between a client 1102 and a server 1104 can be in the form of a data packet adapted to be transmitted between two or more computer processes. The data packet may include a cookie and/or associated contextual information, for example. The environment 1100 includes a communication framework 1106 (e.g., a global communication network such as the Internet) that can be employed to facilitate communications between the client(s) 1102 and the server(s) 1104.

Communications can be facilitated via a wire (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

The client(s) 1102 can include the client 200, client 312, client 322, and the server(s) 114 can include the environments (106 and 302), for example.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented data emphasis system, comprising:
a synchronization component for synchronizing changes to content of one or more shared documents, the changes received from one or more sources; and
an emphasis component for automatically applying visual emphasis to the changed content that is unread, the visual emphasis distinctive on a per-source basis.

2. The system of claim 1, wherein the visual emphasis applied by the emphasis component highlights the unread content in an online and offline state, and without a server.

3. The system of claim 1, wherein the visual emphasis applied by the emphasis component annotates the unread content with a source identifier, which source is an author and the source identifier is initials of the author that provided the changed content.

4. The system of claim 1, further comprising a mapping component for mapping a source to a color.

5. The system of claim 1, further comprising a storage component for storing configuration information associated at least with the unread content, read content, source identity, and source color.

6. The system of claim 1, wherein the synchronization component and the emphasis component operate in cooperation with a collaboration website that processes changes to web page content, the changes synchronized to the one or more sources and, visually and distinctively emphasized on each of the one or more sources according to the source of the change.

7. The system of claim 1, further comprising a user interface for presenting the one or more shared documents, the unread content with the distinctive visual emphasis, and source identifier for each piece of the unread content.

8. The system of claim 1, wherein the emphasis component automatically applies visual emphasis related to synchronization state and changes the visual emphasis based on a corresponding change of the synchronization state.

9. A computer-implemented data emphasis system, comprising:
a synchronization component for synchronizing changes to content of one or more shared documents, the changes generating new content received from one or more users;
an emphasis component for automatically applying visual emphasis to the changed content that is unread, the visual emphasis distinctive on a per-user basis; and
a user interface for presenting the one or more shared documents, the unread content with the distinctive visual emphasis, and author identifier for each piece of the unread content.

10. The system of claim 9, wherein the user interface generates and presents a floating legend of author colors mapped to author identification, the legend automatically presents the author identifier for unread content on a document.

11. The system of claim 9, wherein the emphasis component automatically manages visual emphasis based on navigation away from a page and user interaction with a page.

12. The system of claim 9, further comprising a storage component that is accessible by client that accesses the one or more shared documents, the storage component is a master file that stores mappings of authors and corresponding emphasis information for application to the unread content by the emphasis component.

13. A computer-implemented method of emphasizing shared data, comprising:
receiving changes to content of a shared document;
synchronizing the changes to one or more clients that access the shared document; and
automatically applying emphasis to the changed content to visually distinguish unread content from read content.

14. The method of claim 13, further comprising automatically marking the unread content with author information which indicates an author of the changed content.

15. The method of claim 13, further comprising marking the changes as new content when receiving the changes.

16. The method of claim 13, further comprising storing a mapping of emphasis information and author information in an accessible file for processing by the one or more clients that access the shared document.

17. The method of claim 13, further comprising generating and presenting a resizable widget in association with the changed content, the widget defines the changed content and presents author information for an author of the changed content.

18. The method of claim 13, further comprising automatically applying emphasis to a notebook graphic of a notebook that includes the document and a section of the notebook in which the document is stored during an offline state and without utilization of a server.

19. The method of claim 13, further comprising defining a relationship of different emphasis for correspondingly different authors of unread content to visually distinguish the unread content and authors in the shared document.

20. The method of claim 19, further comprising maintaining the relationship across different clients and machines.
